(19) United States
(12) Patent Application Publication
(10) Pub. No.: US 2026/0265054 A1
(43) Pub. Date: Sep. 10, 2026

(54) PARTICLE SIZE CONTROLLED CRYSTALLIZATION OF PERCHLORATE SALTS USING A CONTINUOUS FLOW TAYLOR-VORTEX REACTOR

(71) Applicant: Government of the United States, as represented by the Secretary of the Air Force, Wright-Patterson AFB, OH (US)

(72) Inventors: Thorsten G. Schroer, Palmdale, CA (US); Gregory E. LeCroy, Lancaster, CA (US); Miguel Aguila, Palmdale, CA (US); Mayra P. Rodriguez, Lancaster, CA (US); Tyler J. Downard, Phelan, CA (US); Brianna L. MacLeod, Lancaster, CA (US); Edgar R. Felix, Lancaster, CA (US)

(21) Appl. No.: 19/070,832

(22) Filed: Mar. 5, 2025

(51) Int. Cl. C01B 11/18; B01D 9/00; B01J 14/00; B01J 19/06; B01J 19/18

(52) U.S. Cl. CPC C01B 11/185; B01D 9/0013; B01D 9/0054; B01D 9/0077; B01J 14/00; B01J 19/06; B01J 19/1806; C01B 11/18; B01D 2009/0086; C01P 2004/61; C01P 2004/62

(57) ABSTRACT

Particle size controlled crystallization of perchlorate salts using a continuous flow taylor-vortex reactor, perchlorate salts made using such process and the use of such perchlorate salts are disclosed. The process yields, in one step, perchlorate salts that have tailored particle sizes, particle size distributions, particle sphericities and roundness ranges that allow for improved solids loadings.

### RIGHTS OF THE GOVERNMENT

The invention described herein may be manufactured and used by or for the Government of the United States for all governmental purposes without the payment of any royalty.

### FIELD OF THE INVENTION

The present invention relates to the particle size controlled crystallization of perchlorate salts using a continuous flow taylor-vortex reactor, perchlorate salts made using such process and the use of such perchlorate salts.

### BACKGROUND OF THE INVENTION

Ammonium perchlorate (AP) and potassium perchlorate (KP) are the most widely used oxidizers in, for example, solid rocket propellant motors, rocket boosters, and explosives. Currently, AP and KP are produced via a batch. Unfortunately, current AP and KP materials do not deliver the desired solids loading. Thus, industry has attempted to solve such problem with additional processing. Even then, desired solids loadings remain elusive.

Applicants recognized that in order to efficiently get improved loadings, AP and KP required certain particle size distributions, particle sphericities and roundness ranges and such properties could only be efficiently delivered via a one-step continuous process. As a result, Applicants disclose a particle size controlled crystallization process for the production of perchlorate salts that uses a continuous flow taylor-vortex reactor. Such process yields, in one step, perchlorate salts that have tailored particle sizes, particle size distributions, particle sphericities and roundness ranges that allow for improved solids loadings.

### SUMMARY OF THE INVENTION

Particle size controlled crystallization of perchlorate salts using a continuous flow taylor-vortex reactor, perchlorate salts made using such process and the use of such perchlorate salts are disclosed. The process yields, in one step, perchlorate salts that have tailored particle sizes, particle size distributions, particle sphericities and roundness ranges that allow for improved solids loadings.

### BRIEF DESCRIPTION OF THE DRAWINGS

The accompanying drawings, which are incorporated in and constitute a part of this specification, illustrate embodiments of the invention and, together with the summary given above, and the detailed description given below, serve to explain the invention.

The accompanying drawings, which are incorporated in and constitute a part of this specification, illustrate embodiments of the present invention and, together with a general description of the invention given above, and the detailed description of the embodiments given below, serve to explain the principles of the present invention.

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described. The description is not to be considered as limited to the scope of the embodiments described herein.

FIG. 1 Depicts a schematic representation of Taylor Vortex Reactor (100) having: Jacketed reactor shell (1), Shaft (2), Reactor inlet cap (3), Reactor outlet cap (4), Reactor inlet port (5), Reactor inlet port (6), Reactor outlet port (7), Jacketed reactor shell inlet port (8), Jacketed reactor shell outlet port (9) and Motor (10).

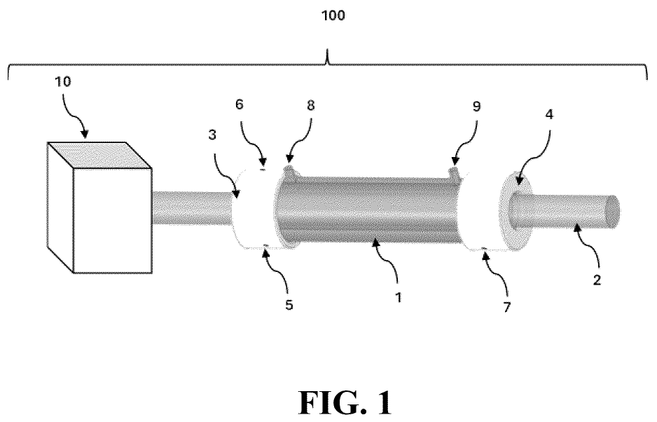

FIG. 2 Depicts a schematic representation of antisolvent crystallization of ammonium perchlorate using Taylor Vortex Reactor 100 having: Perchlorate salt solution and reservoir (200), Anti-solvent and reservoir (201), Perchlorate salt solution dosing pump (210), Anti-solvent dosing pump (211), Temperature control unit (220) and Collection apparatus (230).

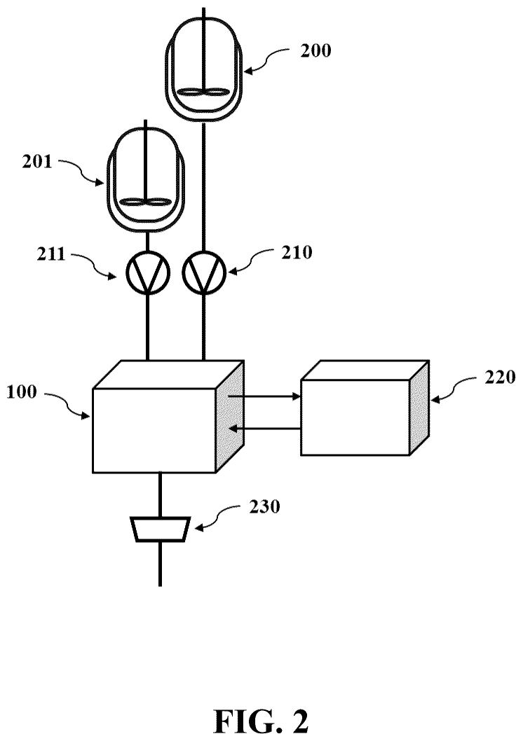

FIG. 3. Depicts a schematic representation of the process for two solvent temperature gradient crystallization of ammonium perchlorate using Taylor Vortex Reactor 100 having: Perchlorate salt solution and reservoir (300), Perchlorate salt solution dosing pump (310), Temperature control unit (320) and Collection apparatus (330).

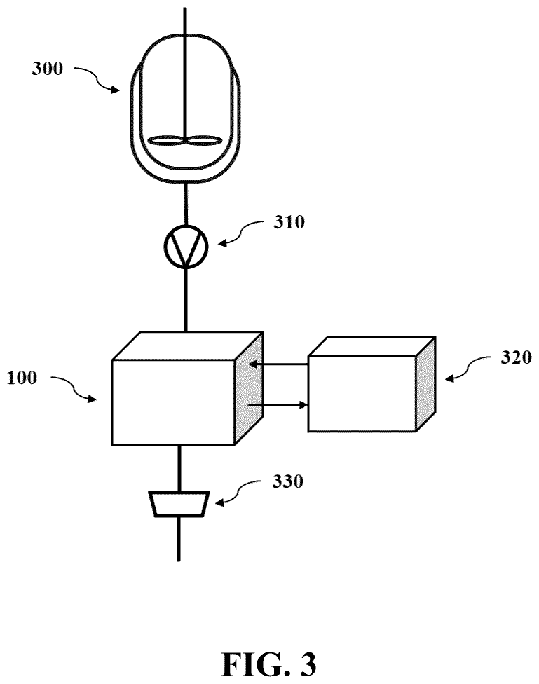

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

### Definitions

Unless specifically stated otherwise, as used herein, the terms “a”, “an” and “the” mean “at least one”.

As used herein, the terms “include”, “includes” and “including” are meant to be non-limiting.

As used herein, the words “about,” “approximately,” or the like, when accompanying a numerical value, are to be construed as indicating a deviation as would be appreciated by one of ordinary skill in the art to operate satisfactorily for an intended purpose.

As used herein, the words “and/or” means, when referring to embodiments (for example an embodiment having elements A and/or B) that the embodiment may have element A alone, element B alone, or elements A and B taken together.

As used herein “miscible” means capable of forming a single phase mixture under the recited reaction conditions in the taylor-vortex reactor.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Process of Making Particulate Perchlorate Salts

In this paragraph Applicants disclose a process of making a particulate perchlorate salts comprising passing a first solution having an initial temperature, said first solution comprising a first solvent selected from water, methanol and/or acetone and a perchlorate salt through a taylor-vortex reactor comprising an inner routable shaft and having an initial temperature to yield a particulate perchlorate salts having a particulate size of from about 1 micron to about 400 microns,
a.) said first solution having a concentration of perchlorate salt in said first solution of 0.1 grams per liter to 400 grams per liter;
b.) said initial temperature of said first solution and said initial temperature of said taylor-vortex reactor, prior to first said solution being passed through said taylor-vortex reactor, having a temperature differential of from 0° C. to 100° C., preferably said initial temperature of said first solution and said initial temperature of said taylor-vortex reactor, prior to first said solution being passed through said taylor-vortex reactor, having a temperature differential of 25° C. to 60° C., a second solution being introduced into said taylor-vortex reactor as said first solution is being passed through said taylor-vortex reactor, said second solution comprising an ammonium and/or potassium cation, and/or a second solvent being introduced into said taylor-vortex reactor as said first solution is being passed through said taylor-vortex reactor, said second solvent being miscible in said first solution;
c.) said taylor-vortex reactor inner routable shaft being rotated at a speed of 0 rotations per minute to about 3000 rotations per minute, preferably said taylor-vortex reactor inner routable shaft being rotated at a speed of about 100 rotations per minute to about 1800 rotations per minute; and d.) said solution having a residence time in said taylor-vortex reactor of about 0.1 minutes to about 60 minutes, preferably said solution having a residence time in said taylor-vortex reactor of about 0.5 minutes to about 30 minutes.

In this paragraph Applicants disclose a process of making a particulate perchlorate salts according to the previous paragraph wherein:
a.) said perchlorate salt comprises ammonium, potassium, or sodium, preferably ammonium and potassium;
b) said second solvent comprises toluene, benzene, chloroform, dichloromethane, diethyl ether, ethyl acetate and/or an alcohol, preferably said solvent comprises toluene;
c.) said second solution comprises ammonium nitrate, ammonium chloride, potassium nitrate or potassium chloride, preferably said second solution comprises ammonium nitrate or potassium chloride, more preferably said second solution has an ammonium or a potassium cation concentration of from about 0.1M to about 8M, most preferably said second solution has an ammonium or a potassium cation concentration of from about 2.5M to about 7M.

In this paragraph Applicants disclose a process of making a particulate perchlorate salts according to the previous two paragraphs wherein said initial temperature of said first solution is from about 10° C. to about 100° C., preferably said initial temperature of said first solution is from about 25° C. to about 60° C.

In this paragraph Applicants disclose a process of making a particulate perchlorate salts according to the previous three paragraphs wherein said solvent first solvent is methanol and said second solvent is toluene, benzene, chloroform, dichloromethane, diethyl ether, ethyl acetate or an alcohol, preferably said second solvent is toluene.

In this paragraph Applicants disclose a process of making a particulate perchlorate salts according to the first three paragraphs of this section titled “Process of Making Particulate Perchlorate Salts” wherein said solvent first solvent is acetone and said second solvent is toluene, benzene, chloroform, dichloromethane, diethyl ether, ethyl acetate or an alcohol, preferably said second solvent is toluene. Table 1 below details certain particulate perchlorate salt size ranges that can be obtained with the listed solvent combinations

| | Acetone | MeOH |
|---|---|---|
| | 20 g/L | 50 g/L |
| Toluene | 2-8 | 3-15 |
| Diethyl Ether | 3-25 | 5-14 |
| Chloroform | 2-12 | 3-15 |
| Ethyl Acetate | — | 3-12 |
| Heptane | 5-20 | — |
| IPA | — | 20-60 |

Antisolvent size ranges. All in microns.

### Test Methods

Particle Size Analysis For purposes of this specification and claims particle size should be determined as follows:
a) Using a Microtrac S3500 Bluewave Particle Size Analyzer with a Solvent Delivery Controller, which utilizes laser diffraction for identification of particle size.
b) To a sample vial containing 10 mg of ammonium perchlorate sample: add 1 mL of a wetting solution that contains, based on total wetting solution weight, 2 wt % petroleum sulfonic acid, sodium salts and 98 wt. % n-heptane filtered with 0.22 μm filter) to form a mixture of ammonium perchlorate, petroleum sulfonic acid, sodium salts and n-heptane.
c) Agitate the mixture of b) for one minute.
d) Add 5 mL of n-heptane filtered with a 0.22 μm filter and swirl together.
e) Complete 3 sample runs using a new sample each time using the Microtrac S3500 Bluewave Particle Size Analyzer. The Microtrac S3500 Bluewave Particle Size
Analyzer will report a D50, a D10 and a D90 for each sample. For purposes of this specification the particle size is the average of the reported D50s.
Calculate the coefficient of variance as follows:

$$Sample coefficient of variance = \frac{( D 90 - D 10 )}{D 50} * 100$$

Add the three coefficient of variances and divide by three. For purposes of this specification the coefficient of variance is the average that is obtained.

### EXAMPLES

The following examples and methods are presented as illustrative of the present invention or methods of carrying out the invention, and are not restrictive or limiting of the scope of the invention in any manner.

Example 1. Taylor Vortex Reactor Crystallization of Ammonium Perchlorate in a Toluene: Methanol Antisolvent System. The temperature of a TVR (15 mL) equipped with a 25.4 mm shaft and annular gap of 1.4 mm was set to 25° C. with a recirculating chiller. A methanol solution containing 50 g/L ammonium perchlorate and toluene, as the antisolvent, were each dosed into the TVR at 7.5 mL/min. The shaft was rotated at 600 RPM with an inline servo motor. After 5 minutes of priming the reactor, the crude AP particles were collected into a scintillation vial. The AP was allowed to settle within the vial and the mother liquor was decanted. The collected particles were then washed with heptane over a 0.65 μm PVDF filter paper. The particles were dried in an oven at 60° C. overnight and analyzed with a particle size analyzer. The particle size analysis showed a D50 of 10 μm with a CV of 138%.

Example 2: Taylor Vortex Reactor Crystallization of Ammonium Perchlorate using a Thermal Gradient in an Aqueous System. The temperature of a TVR (15 mL) equipped with a 25.4 mm shaft and annular gap of 1.4 mm was set to 10° C. with a recirculating chiller. An aqueous solution containing 375 g/L AP was heated to 60° C. in a reservoir. The AP solution was dosed into the TVR at 5 mL/min while the shaft was rotated at 1800 RPM with an inline servo motor. After priming the system for 9 minutes, AP particles were collected onto a filter with a 2.5 μm cellulose filter paper, washed with diethyl ether, then dried overnight at 60° C. in an oven. The particle size analysis showed a D50 of 130 μm with a CV of 105%.

Example 3. Taylor Vortex Reactor Crystallization of Ammonium Perchlorate using a Thermal Gradient in Methanol. The temperature of a TVR (15 mL) equipped with a 25.4 mm shaft and annular gap of 1.4 mm was set to 0° C. with a recirculating chiller. A methanol solution containing 70 g/L AP was heated to 50° C. and dosed into the TVR at 15 mL/min. The shaft was rotated at 1000 RPM with an inline servo motor. After priming the system for 3 minutes, samples were collected into a fitted funnel with 2.5 μm cellulose filter paper. The particles were dried overnight in an oven and analyzed with a particle size analyzer. The particle size analysis showed a D50 of 85 μm with CV of 117%.

Example 4. Taylor Vortex Reactor Crystallization of Ammonium Perchlorate using a Thermal Gradient in a Methanol: Water System. The temperature of a TVR (15 mL) equipped with a 25.4 mm shaft and annular gap of 1.4 mm was set to 0° C. with a recirculating chiller. A 50:50 v:v methanol:water solution containing 98 g/L AP kept at 25° C. was dosed into the TVR at 5 mL/min. The resulting residence time was 3 min. The shaft was rotated at 1000 RPM with an inline servo motor. After priming the system for 9 minutes, the particles were collected on a fritted funnel with 2.5 μm cellulose filter paper. The AP was then dried overnight at 60° C. in an oven. The particle size analysis showed a D50 of 97 μm with a CV of 110%.

Tuning the particle size of AP may be achieved by adjusting the concentration of the starting solution and retention time. A 50:50 v:v methanol:water solution containing 200 g/L AP kept at 50° C. was dosed into the TVR at 15 mL/min. The resulting residence time was 1 min. The shaft was rotated at 1000 RPM with an inline servo motor. After priming the system for 9 minutes, the particles were collected on a fritted funnel with 2.5 μm cellulose filter paper. The AP was then dried overnight at 60° C. in an oven. The particle size analysis showed a D50 of 120 μm with a CV of 115%.

Example 5. Taylor Vortex Reactor Crystallization of Ammonium Perchlorate using Metathesis between Sodium Perchlorate and Ammonium Nitrate. The temperature of a TVR (7 mL) equipped with a 10 mm shaft and annular gap of 2 mm was set to 25° C. with a recirculating chiller. A 7M solution of ammonium nitrate in water and a 5M solution of sodium perchlorate are dosed into the TVR at 7 mL/min each. The shaft was rotated at 500 RPM with an inline servo motor. After priming the system for 3 minutes, samples were collected into a temperature controlled fritted funnel at 25° C. fitted with 2.5 μm cellulose filter paper. The particles were dried overnight in an oven and analyzed with a particle size analyzer. The particle size analysis showed a D50 of 137 μm with CV of 105%.

Example 6. Taylor Vortex Reactor Crystallization of Potassium Perchlorate using Metathesis between Sodium Perchlorate and Potassium Chloride. The temperature of a TVR (15 mL) equipped with a 24.5 mm shaft and annular gap of 1.4 mm was set to 25° C. with a recirculating chiller. A 2.5 M solution of potassium chloride in water and a 5M solution of sodium perchlorate are dosed into the TVR at 9 mL/min and 4.5 mL/min, respectively. The shaft was rotated at 300 RPM with an inline servo motor. After priming the system for 3 minutes, samples were collected into a temperature controlled fritted funnel at 25° C. fitted with 2.5 μm cellulose filter paper. The particles were dried overnight in an oven and analyzed with a particle size analyzer. The particle size analysis showed a D50 of 54 μm with CV of 105%.

While the present invention has been illustrated by the description of one or more embodiments thereof, and while the embodiments have been described in considerable detail, they are not intended to restrict or in any way limit the scope of the appended claim to such detail. Additional advantages and modification will be readily apparent to those skilled in the art. The invention in its broader aspects is therefore not limited to the specific details, representative apparatus and methods and illustrative examples shown and described. Accordingly, departures may be made from such details without departing from the scope or the spirit of the general inventive concept exemplified herein.

What is claimed is:

1. A process of making a particulate perchlorate salts comprising passing a first solution having an initial temperature, said first solution comprising a first solvent selected from water, methanol and/or acetone and a perchlorate salt through a taylor-vortex reactor comprising an inner routable shaft and having an initial temperature to yield a particulate perchlorate salts having a particulate size of from about 1 micron to about 400 microns,
a.) said first solution having a concentration of perchlorate salt in said first solution of 0.1 grams per liter to 400 grams per liter;
b.) said initial temperature of said first solution and said initial temperature of said taylor-vortex reactor, prior to first said solution being passed through said taylor-vortex reactor, having a temperature differential of from 0° C. to 100° C.; a second solution being introduced into said taylor-vortex reactor as said first solution is being passed through said taylor-vortex reactor, said second solution comprising an ammonium and/or potassium cation; and/or a second solvent being introduced into said taylor-vortex reactor as said first solution is being passed through said taylor-vortex reactor, said second solvent being miscible in said first solution;
c.) said taylor-vortex reactor inner routable shaft being rotated at a speed of 0 rotations per minute to about 3000 rotations per minute; and
d.) said solution having a residence time in said taylor-vortex reactor of about 0.1 minutes to about 60 minutes.

2. The process of claim 1 wherein:
a) said initial temperature of said first solution and said initial temperature of said taylor-vortex reactor, prior to first said solution being passed through said taylor-vortex reactor, having a temperature differential of 25° C. to 60° C.,
b) said taylor-vortex reactor inner routable shaft being rotated at a speed of about 100 rotations per minute to about 1800 rotations per minute; and
c.) said solution having a residence time in said taylor-vortex reactor of about 0.5 minutes to about 30 minutes.

3. The process of claim 1 wherein:
a.) said perchlorate salt comprises ammonium, potassium, or sodium;
b) said second solvent comprises toluene, benzene, chloroform, dichloromethane, diethyl ether, ethyl acetate and/or an alcohol; and
c.) said second solution comprises ammonium nitrate, ammonium chloride, potassium nitrate or potassium chloride.

4. The process of claim 3 wherein:
a) said perchlorate salt comprises ammonium and potassium;
b) said second solvent comprises toluene; and
c) said second solution comprises ammonium nitrate or potassium chloride.

5. The process of claim 4 wherein said second solution has an ammonium or a potassium cation concentration of from about 0.1M to about 8M.

6. The process of claim 5 wherein said second solution has an ammonium or a potassium cation concentration of from about 2.5M to about 7M.

7. The process of claim 1 wherein said initial temperature of said first solution is from about 10° C. to about 100° C.

8. The process of claim 7 wherein said initial temperature of said first solution is from about 25° C. to about 60° C.

9. The process of claim 1 wherein said first solvent is methanol and said second solvent is toluene, benzene, chloroform, dichloromethane, diethyl ether, ethyl acetate or an alcohol.

10. The process of claim 9 wherein said second solvent is toluene.

11. The process of claim 1 wherein said solvent first solvent is acetone and said second solvent is toluene, benzene, chloroform, dichloromethane, diethyl ether, ethyl acetate or an alcohol.

12. The process of claim 11 wherein said second solvent is toluene.
